(19) United States
(12) Patent Application Publication
(10) Pub. No.: US 2008/0094400 A1
(43) Pub. Date: Apr. 24, 2008

(54) Content Based Graphical User Interface Application

(76) Inventors: Ning-Nibble Yang, Beijing (CN); Jyri P. Salomaa, Beijing (CN); Jouka Mattila, Tampere (FI); Ciaran Harris, Seami (FI); Elina M. Koivisto, Helsinki (FI)

Correspondence Address: PERMAN & GREEN, 425 POST ROAD, FAIRFIELD, CT, 06824, US

(21) Appl. No.: 11/550,517

(22) Filed: Oct. 18, 2006

(51) Int. Cl. G06T 13/00

(52) U.S. Cl. 345/473

(57) ABSTRACT

A method including processing and modeling a script stored in a first device, determining a state transition diagram of the first device based on the script model, utilizing the state transition diagram to determine a state of the first device and displaying an image based on the state of the first device in response to internal and/or external events associated with the first device.

### BACKGROUND

1. Field

The present embodiments relate to user interfaces and, more particularly, to animated user interfaces.

2. Brief Description of Related Developments

In conventional electronic devices, such as mobile phones and the like, avatars or animations of characters or objects may be used for visualization of specific device functions, such as an animated face during a telephone conversation or a dance visualization of a stream of music.

Conventional devices may have limited processing capability and the ability to store content such as MP3 files, flash players, video files, etc. to enable the device to play one or more kinds of content such as music, video, display still images and the like. However, these conventional devices do not provide an emotional connection with a user. Rather any emotional connection a user may have with the device is derived implicitly from the content played on the device.

It would be advantageous to have an electronic device that may provide an emotional connection to its user, apart from any content played on the device, that can support for example, content synchronization, user interaction, user customization, etc.

### SUMMARY

In one embodiment, a method is provided. The method includes processing and modeling at least one script stored in a first device, determining a state transition diagram of the first device based on the script model, utilizing the state transition diagram to determine a state of the first device and displaying an image based on the state of the first device in response to internal and/or external events associated with the first device.

In another embodiment, an apparatus is provided. The apparatus includes a memory for storing at least one script and a processor connected to the memory. The processor is configured to process and model the at least one script, determine a state transition diagram of the apparatus based on the script model, utilize the state transition diagram to determine a state of the apparatus and display an image based on the state of the device in response to internal and/or external events associated with the apparatus.

In one embodiment, a system is provided. The system includes a first apparatus and a second apparatus, the first and second apparatus each including a memory for storing at least one script and a processor connected to the memory. Each processor is configured to process and model the at least one script, determine a state transition diagram of a respective apparatus based on the script model, utilize the state transition diagrams to determine a state of the respective apparatus and display an image based on the state of the respective apparatus in response to internal and/or external events associated with the respective apparatus.

In another embodiment a computer program product is provided. The computer program product includes a computer useable medium having computer readable code means embodied therein for causing a computer to display an image based on a state of a device. The computer readable code means in the computer program product includes computer readable code means for causing a computer to process and model at least one script stored in a first device, determine a state transition diagram of the first device based on the script model, utilize the state transition diagram to determine a state of the first device and display an image based on the state of the first device in response to internal and/or external events of the first device.

### BRIEF DESCRIPTION OF THE DRAWINGS

The foregoing aspects and other features of the present embodiments are explained in the following description, taken in connection with the accompanying drawings, wherein:

FIG. 1 shows a schematic illustration of a communication system, as an example in which aspects of the invention may be applied;

FIG. 2 illustrates an apparatus in accordance with an embodiment;

FIG. 3 shows another apparatus in accordance with an embodiment;

FIG. 4 shows an apparatus in accordance with an embodiment;

FIGS. 5A-5D illustrate an animated image in accordance with an embodiment;

FIGS. 6 and 7 illustrate animated images in accordance with an embodiment;

FIGS. 8A-8C illustrate a transfer of images in accordance with an embodiment;

FIG. 9 illustrates a vector space model in accordance with an embodiment;

FIG. 10 illustrates a state transition diagram constructed in accordance with the model of FIG. 9;

FIG. 11 illustrates is a block diagram of an apparatus incorporating features of an embodiment; and

FIG. 12 shows a flow diagram in accordance with a method of an embodiment.

### DETAILED DESCRIPTION OF THE EXEMPLARY EMBODIMENT(S)

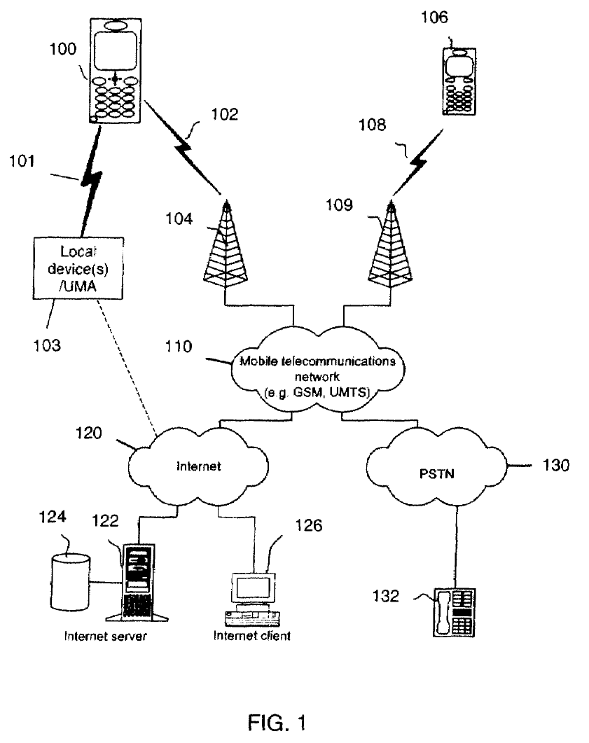

FIG. 1 is a schematic illustration of a communications system, as an example, of an environment in which a communications device 100 incorporating features of an exemplary embodiment may be applied. Although aspects of the invention will be described with reference to the embodiments shown in the drawings and described below, it should be understood that these aspects could be embodied in many alternate forms of embodiments. In addition, any suitable size, shape or type of elements or materials could be used.

The communication system of FIG. 1, may be used in accordance with the disclosed embodiments to provide an emotional connection between a communication device or terminal and its user, apart from any content played on the device, that can support for example, content synchronization, user interaction, user customization, etc.

In the communication system of FIG. 1, various communications services such as cellular voice calls, www/wap browsing, cellular video calls, data calls, facsimile transmissions, music transmissions, still image transmission, video transmissions, electronic message transmissions and electronic commerce may be performed between the mobile terminal 100 and other devices, such as another mobile terminal 106, a stationary telephone 132, or an internet server 122. It is to be noted that for different embodiments of the mobile terminal 100 and in different situations, different ones of the communications services referred to above may or may not be available. The aspects of the invention are not limited to any particular set of services in this respect.

The mobile terminals 100, 106 may be connected to a mobile telecommunications network 110 through radio frequency (RF) links 102, 108 via base stations 104, 109. The mobile telecommunications network 110 may be in compliance with any commercially available mobile telecommunications standard such as GSM, UMTS, D-AMPS, CDMA2000, FOMA and TD-SCDMA.

The mobile telecommunications network 110 may be operatively connected to a wide area network 120, which may be the internet or a part thereof. An internet server 122 has data storage 124 and is connected to the wide area network 120, as is an internet client computer 126. The server 122 may host a www/hap server capable of serving www/hap content to the mobile terminal 100.

For example, a public switched telephone network (PSTN) 130 may be connected to the mobile telecommunications network 110 in a familiar manner. Various telephone terminals, including the stationary telephone 132, may be connected to the PSTN 130.

The mobile terminal 100 is also capable of communicating locally via a local link 101 to one or more local devices 103. The local link 101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 103 can, for example, be various sensors that can communicate measurement values to the mobile terminal 100 over the local link 101. The local devices 103 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 100 may thus have multi-radio capability for connecting wirelessly using mobile communications network 110, WLAN or both. Communication with the mobile telecommunications network 110 may also be implemented using WiFi, WiMax, or any other suitable protocols, and such communication may utilize unlicensed portions of the radio spectrum (e.g. unlicensed mobile access (UMA)). The above examples are not intended to be limiting, and any suitable type of link may be utilized.

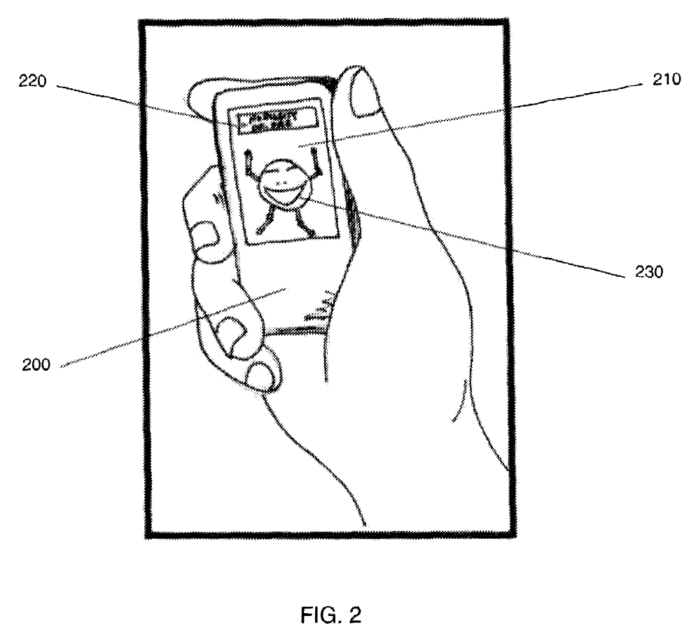

In one embodiment, the apparatus 100 may be any suitable apparatus capable of presenting graphics or animations such as, for example, a mobile phone, a PDA, laptop or desktop computer an electronic music player (e.g. MP3 player and the like) and the like as will be described below. As can be seen in FIG. 2, the apparatus 100 may be an electronic music player 200. The electronic music player may include a user interface having a display 210 and a keypad (not shown). The display may have an area 220 for displaying, for example, artist and song information. The display 210 may be integral to the apparatus 200 or the display may be a peripheral display connected to the apparatus 200. A pointing device, such as for example, a stylus, pen or simply the user's finger may be used with the display 210. In alternate embodiments any suitable pointing device may be used. In other alternate embodiments, the display may be a conventional display.

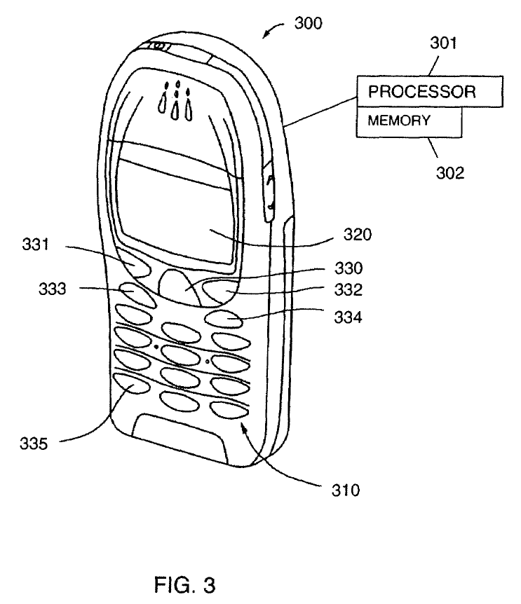

Another embodiment 300 of an apparatus 100 is illustrated in more detail in FIG. 3. The apparatus may be a mobile communications device 300 that may have a keypad 310 and a display 320. The keypad 310 may include any suitable user input devices such as, for example, a multi-function/scroll key 330, soft keys 331, 332, a call key 333 and end call key 334 and alphanumeric keys 335. The display 320 may be any suitable display, such as for example, a touch screen display or graphical user interface. The device 300 may also include other suitable features such as, for example, a camera, loud speaker, connectivity port or tactile feedback features. The device 300 may also include an electronic music player. The mobile communications device may have a processor 301 connected to the display for processing user inputs and displaying information on the display 320. A memory 302 may be connected to the processor 301 for storing any suitable information and/or applications associated with the mobile communications device 300 such as, image files, music files, phone book entries, calendar entries, etc.

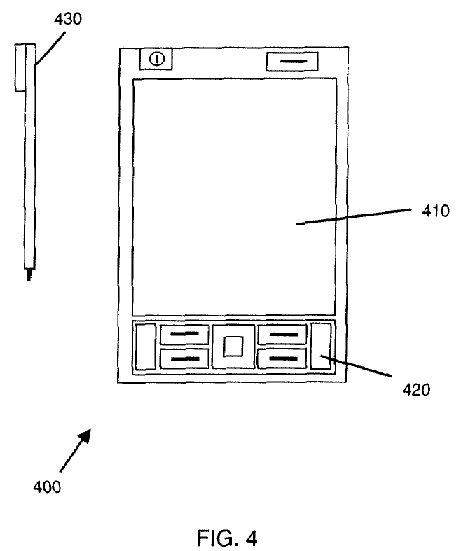

In another embodiment, the device 100, may be for example, a PDA style device 400 illustrated in FIG. 4. The PDA 400 may have a keypad 420, a display 410 and a pointing device 430 for use on the touch screen display 410. The display 410 and pointing device 430 may be substantially similar to the display 210 and pointing device described above with respect to FIG. 2. In alternate embodiments, the display may be a conventional display. In still other alternate embodiments, the device may be a personal communicator, a tablet computer, a laptop or desktop computer, a television or television set top box, gaming console or any other suitable device capable of containing the display 210 and supported electronics such as the processor 301 and memory 302.

The embodiments described herein will be described with reference to the electronic music player 200 for exemplary purposes only and it should be understood that the embodiments could be applied equally to any suitable device incorporating a display, processor, memory and supporting software or hardware. It should also be noted that the features of the apparatus described herein may be combined together to form another apparatus for practicing the disclosed embodiments, such as, for example, a mobile phone with an MP3 player.

To enhance the user's emotional experience a device 100, such as the player 200, may be configured to utilize any suitable content such as, for example, preprocessed content and/or software generated content. Examples of preprocessed content include, but are not limited to, MPEG movies, FLASH clips, GIF images, JPEG images, MP3 music/sound files, etc. Examples of software generated content include, but are not limited to, content that is generated on the device without media files such as, fractal images (e.g. Mandelbrot images) where the content can be presented in simple mathematical formulas. In alternate embodiments, more sophisticated graphics can be generated using, for example, graphic languages such as Open GL and the like.

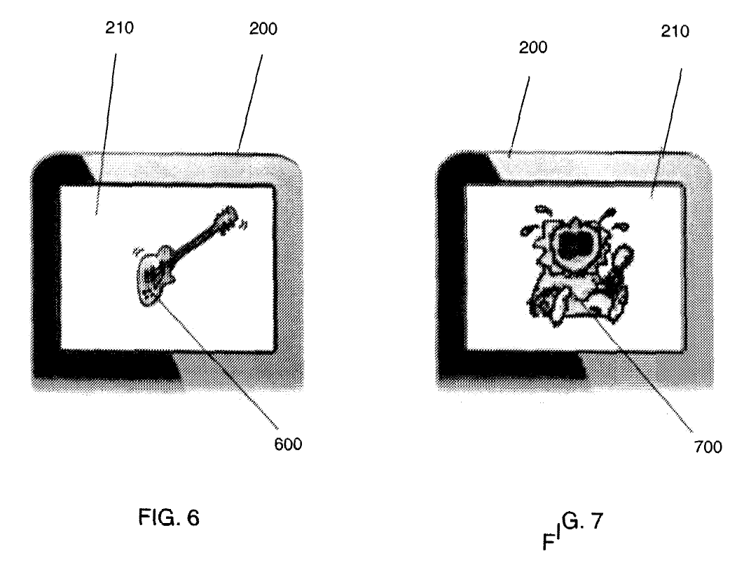

A user's emotional experience with, for example, the electronic music player 200 may be enhanced by, for example, having the user interface react to any suitable event of the device. The events may include, but are not limited to music currently playing on the device or to external events. The external events include, but are not limited to, data transfer between apparatus 100 such as file transfers, email, SMS or MMS messaging or telephone conversations. For example, when music is playing, the electronic music player may include suitable algorithms stored in a memory that cause the presentation any suitable animated or a still image, graphics, text etc. (hereinafter collectively referred to as “images”). For example, a vibrating guitar image 600 as shown in FIG. 6 may be presented to a user when the player 200 is playing rock music. In alternate embodiments, any suitable image may be presented on the display. For example, when jazz is playing a vibrating saxophone may be presented or when classical music is playing a piano with moving keys may be presented on the display.

The images presented to the user in response to an event may be user defined or the correlation between certain images and a type of event may be defined during manufacture of the player 200. The manufacturer defined images may be the default images for a certain type of event such as, for example, a genre of music which the user may change or customize (e.g. download new images from the internet, computer, another music player, mobile phone, camera, etc).

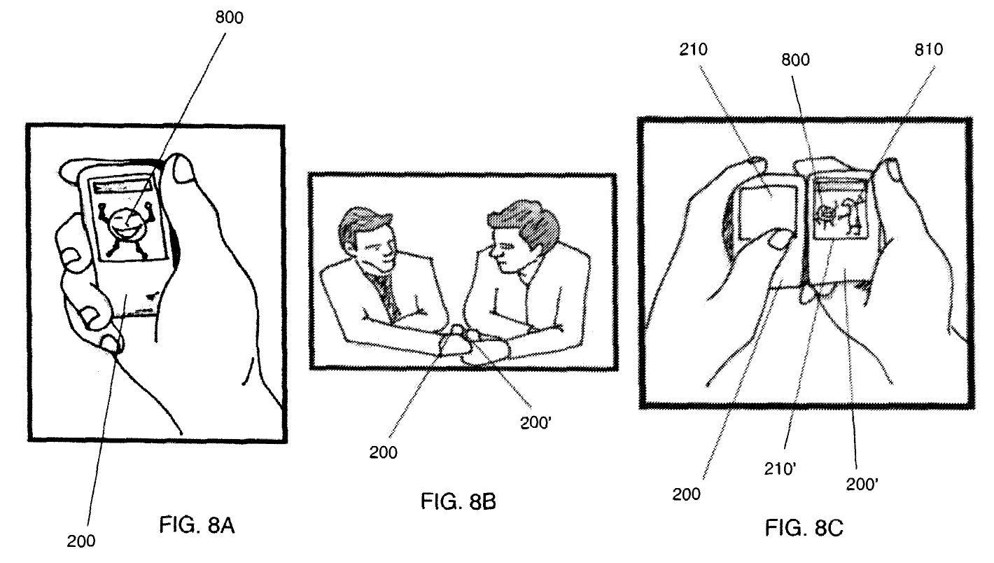

In another example of enhancing a user's emotional experience, one player 200 may be placed next to another player 200′ as shown in FIGS. 8A-8C. Where the players 200, 200′ are placed next to each other, the image such as the avatar 230, 800 or any other suitable animated or still image from player 200 may move from the display of player 200 to the display of player 200′. When the players are located next to each they may communicate through any suitable wired connection or through any suitable short range wireless communication protocol such as, for example, bluetooth, infrared communications or any other suitable protocol. In alternate embodiments, when the players 200, 200′ are apart from each other they may communicate through any suitable long range communication protocols such as those associated with, for example, a cellular network, a WLAN, internet or any other suitable network.

The image from player 200 may interact with an image on player 200′. The interaction between the images may include merging of the images, animating the images so that the images appear to be cooperating with each other, etc. Where, for example music is playing on the players 200, 200′ the avatar from player 200 may dance with the avatar 810 or any other suitable animated or still image on player 200′.

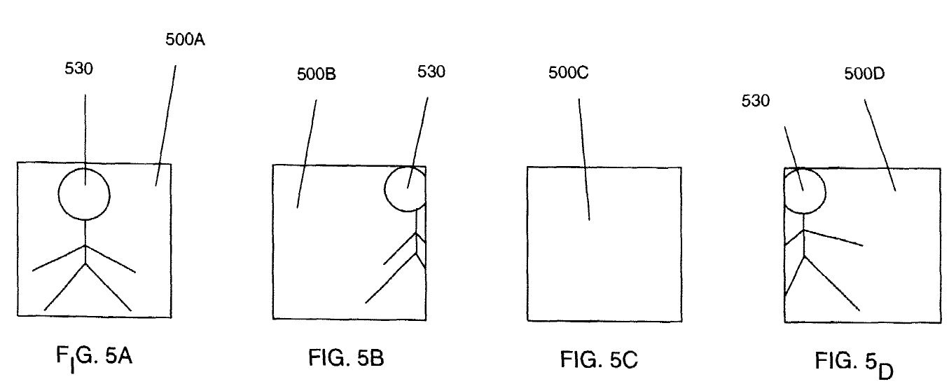

The images may move from one device to another device through, for example, one or more animated graphics files stored in a memory of the players 200, 200′. In alternate embodiments, the images may be stored in the memory of one player and transferred to the other player or players during the animation sequence. In other alternate embodiments, some of the image files for the animation may be stored on one player 200, while complimentary image files may be stored on the other player 200′. For example, FIG. 4 shows four image files that may be stored in the players 200, 200′. In alternate embodiments, any suitable number of image files may be utilized to create the animated images. To create the appearance that the avatar 530 is moving from, for example, the display of player 200 to the display of player 200′, the player 200 may be configured to display the image files in the sequence of 5A, 5B and 5C while the player 200′ may be configured to display the image files in the sequence of 5C, 5D and 5A. It is noted that the devices may be configured to communicate with each other so that player 200′ does not start displaying the images until after player 200 has displayed the last image file in its sequence of images (e.g. the image file shown in FIG. 5C). In alternate embodiments, the images may be displayed on the devices 200, 200′ at any suitable time.

In another example, in an interactive application that is run on the device 100, any suitable attribute of the image such as, for example, appearance, size, age, motions, etc. may progress, change be created or deleted or otherwise be modified on the display of the device(s) in dependence on a user's progress in the interactive application. The interactive applications may include, but are not limited to, games, educational applications, etc. that apply to a single device or to multiple devices that are in communication with one another.

For example, in an educational application a dog may be presented to the user. As the user's knowledge increases the dog may grow from a puppy to an adult dog. In another example, one or more devices 100 may be configured to for a game of “hide and seek” so that when an individual is found, the seeker may send the found individual a notification that he/she has been found. For example, the seeker may send the found individual a “bullet” that appears to be moving into the display of the individuals device as a “bang” sound is being played. As a further example, if a person using device 200 has a collection of music but is missing some songs, that person may search a collection of music stored in device 200′ for the missing songs. As the search is in progress a “digging worker” may be displayed on the device 200 and or device 200′ to emotionalize the search process.

The enhancements to a user's emotional experience may be implemented in any suitable manner such as by, for example, software or hardware. In other alternate embodiments the enhancements may be implemented by a combination of software and hardware. The player 200 may include software algorithms that detect and gather information pertaining to the connections of content (e.g. music, videos, etc.) playing on the player 200 and/or regarding external events (e.g. proximity to other compatible players/devices). The connections may be any suitable links between or content associate with, for example, different device functions, user inputs, events of the device etc. The connections may be user defined or they may be created during manufacture of the device 100 (e.g. default connections that the user may change or modify). In alternate embodiments the connections may be defined in any suitable manner.

The player 200 may also include software algorithms that allow the user to control and customize the emotional features of the player 200. The player may be configured to utilize any suitable files such as, for example, script files for the user control and customization of the emotional features. In alternate embodiments, the user may control and customize the emotional features of the player in any suitable manner. The player may be configured to process the script files, gather information about connections and show emotional actions or features accordingly.

In one example, the connections may be points in an n-space vector model of a script file. The connections may be based on, for example, elements of certain categories that may pertain to device activities. The categories may include “who am I now (what's my role now)”, “when to play, “what to play”, “how to play”, “where to play”, etc. For example, “what to play” may relate to the different content (e.g. music, image files, video files, etc.) available to be played on the player 200. “How to play” may relate to rules that indicate which emotional sequences are played. For example, “how to play” may determine if “matchmaking” (e.g. comparing files on different devices) is needed to decide what information is to be transferred from device to device, whether a file is to be transferred before playing it, whether a reply to another device is needed after playing a file, etc. In alternate embodiments, any number and type of suitable categories and elements of categories may be utilized. Exemplary connections that form a script include:
Play my idol slides and his songs shuffle in standalone mode (who and when to play);
Play ringing tone music at 5:30 a.m. every morning (when to play);
When playing rock music play guitar vibrating image (what to play);
When devices are placed in proximity to each other (when to play) and at a party (where to play):
   Sender (who to play): matchmaking recently played music by artists (how to play);
   Sender (who to play): transfer different music files (how to play);
   Receiver (Who to play): play music files transferred on birthday (when to play);
   Receiver (who to play): reply a message back to Sender (how to play).

The device 100 may include suitable algorithms to convert the connections into script files. In alternate embodiments, the script files may be created in any suitable manner. Any suitable files may be utilized in creating the scripts such as XML files. Examples of scripts in an XML file format may include:

```
<on play_song>
  if genre = ”rock” then play_animation = ”rock.gif”
loop = “1”
  if album_art = “1” then display_album_art
<on play_song>
<on stop_song>
  stop_animation
</on stop_song>
and
<on match_players>
  <choose random>
    <if recently_played(matching_artist)  = “1” then
    share(matching_artist)>
    <if recently_played(matching_genre)  = “1” then
    share(matching_genre)>
    <if recently_played(matching_song) = “1” then play_animation =
    “friends.gif” loop = “0”>
    <if last_played(matching_song) = “0” then play_animation =
    “cry-baby.gif” llop = “0”>
  <choose random.
</on match_players>
```

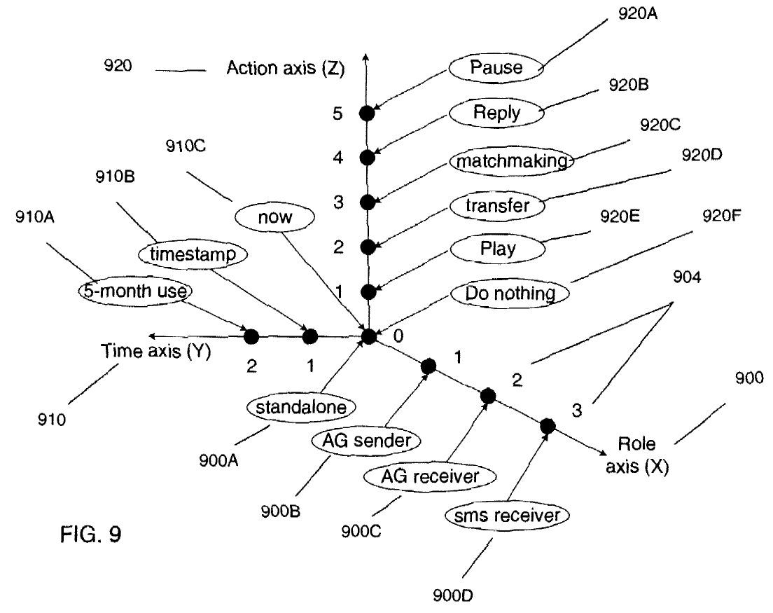

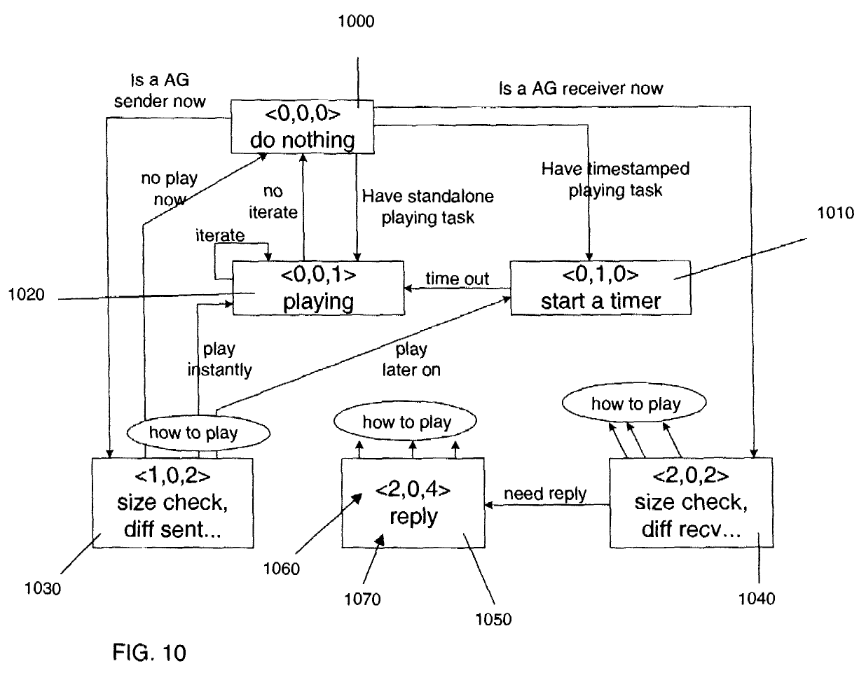

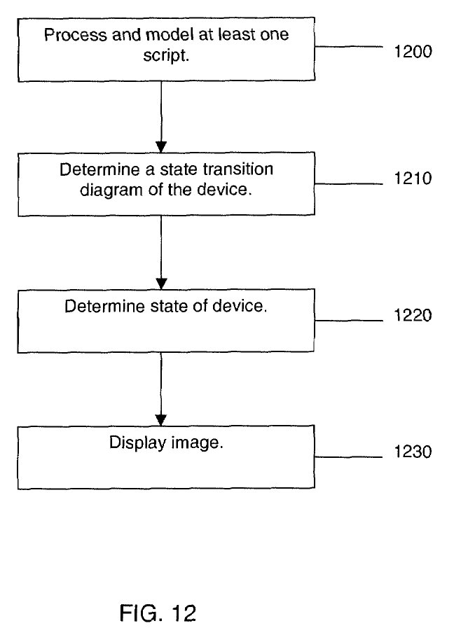

The device 100 may parse the script files using an n-vector space as shown in FIG. 9 (Block 1200, FIG. 12). Each axis of the n-vector space may represent one category of device activity as an enumeration of its elements (e.g. how to play, when to play, who to play, an environment such as a party or game, the music metadata such as type of music and artists, image metadata such as type of image and size of image, etc). For example, in FIG. 9 the n-vector space includes three axes 900-920. Each of the axes 900-920 include related elements. For example, axis 900 includes elements 900A-900D pertaining to “who to play”, axis 910 includes elements 910A-910C pertaining to “when to play” and axis 920 includes elements 920A-920F pertaining to “how to play”. Each point in the n-vector space may represent a potential state of the device 100. The device 100 may utilize this vector model to translate its script files into the state transition diagram as shown in FIG. 10 (Block 1210, FIG. 12). The device 100 may utilize this vector model of the script to determine the state of the device 100 (Block 1220, FIG. 12). Each state includes information on one connection of the device's 100 content and some external events associated with the device so that by running this state transition machine, at least one set of animations may be run based on several different internal (e.g. timers, content type change) or external (e.g. two devices brought in proximity to each other) events (Block 1230, FIG. 12). It should be noted that when more than one device are interacting with each other, each device determines its state as described above. The internal and/or external events resulting from the interaction of the devices can trigger the devices to show the emotional content as described herein.

Referring to FIG. 10, a schematic for an exemplary state machine is shown. Each of the state blocks includes a position 1060 in the n-vector space and a description 1070 of the state. For example, in block 1000 the state of the device 100 is to do nothing as represented by the coordinates <0,0,0>where the first coordinate number is a position on the X axis 900, the second coordinate number is a position on the Y axis 910 and the third coordinate number is a position on the Z axis 920. In block 1020 the device 100 is playing, for example, a music file as represented by the coordinates <0,0,1>. Block 1030 indicates a state where the device 100 is in a sending mode and is transferring information “now” as indicated by the coordinates <1,0,2>. Similarly, blocks 1040 and 1050 respectively indicate a state where the device is in a receiving mode and is receiving information and sending a reply in response to the received information.

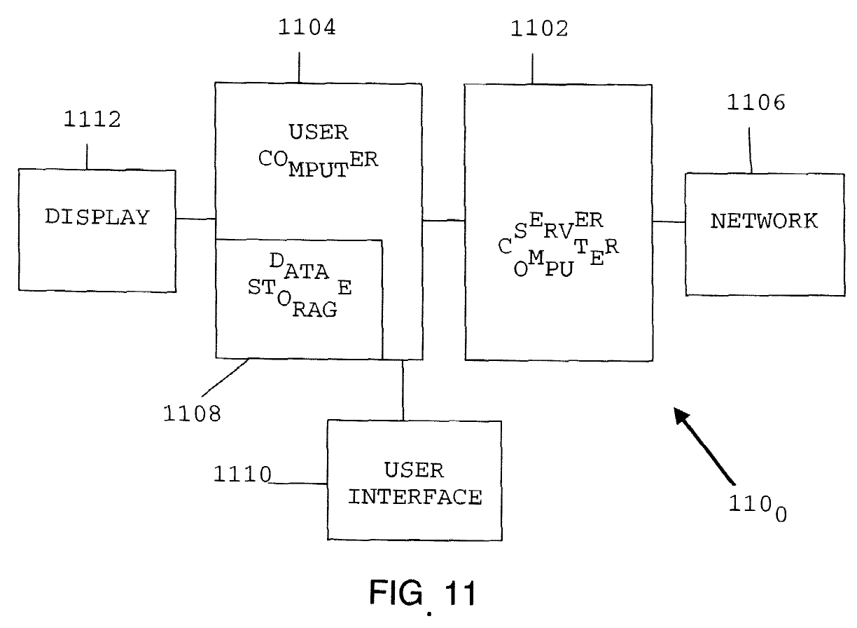

The disclosed embodiments may also include software and computer programs incorporating the process steps and instructions described above that are executed in different computers. FIG. 11 is a block diagram of one embodiment of a typical apparatus 1100 incorporating features that may be used to practice the present invention. As shown, a computer system 1102 may be linked to another computer system 1104, such that the computers 1102 and 1104 are capable of sending information to each other and receiving information from each other. In one embodiment, computer system 1102 could include a server computer adapted to communicate with a network 1106. Computer systems 1102 and 1104 can be linked together in any conventional manner including, for example, a modem, hard wire connection, or fiber optic link. Generally, information can be made available to both computer systems 1102 and 1104 using a communication protocol typically sent over a communication channel or through a dial-up connection on ISDN line. Computers 1102 and 1104 are generally adapted to utilize program storage devices embodying machine readable program source code which is adapted to cause the computers 1102 and 1104 to perform the method steps of the present invention. The program storage devices incorporating features of the invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1102 and 1104 may also include a microprocessor for executing stored programs. Computer 1102 may include a data storage device 1108 on its program storage device for the storage of information and data. The computer program or software incorporating the processes and method steps incorporating features of the present invention may be stored in one or more computers 1102 and 1104 on an otherwise conventional program storage device. In one embodiment, computers 1102 and 1104 may include a user interface 1110, and a display interface 1112 from which features of the present invention can be accessed. The user interface 1110 and the display interface 1112 can be adapted to allow the input of queries and commands to the system, as well as present the results of the commands and queries.

Aspects of the invention may provide a user with an enhanced emotional experience while using the device 100 and give the user a sense of satisfaction with the device. Customization of the emotional features of the device promotes a user to express the user's identity. In alternate embodiments, a device community may be set up by user's, device manufacturers, content providers or any combination thereof to provide support to a user of the device.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
processing and modeling at least one script stored in a first device;
determining a state transition diagram of the first device based on the script model;
utilizing the state transition diagram to determine a state of the first device; and
displaying an image based on the state of the first device in response to internal and/or external events associated with the first device.

2. The method of claim 1, wherein processing and modeling a script comprises modeling the script in an n-vector space model.

3. The method of claim 1, wherein the image is an animated image.

4. The method of claim 3 further comprising:
transferring the animated image from a display of the first device to a display of a second device.

5. The method of claim 4, wherein a first portion of the animated image is stored in the first device and a second portion of the animated image is stored in the second device.

6. The method of claim 4, wherein the animated image from the first device interacts with an animated image of the second device.

7. The method of claim 1, wherein the script comprises connections, the connections being based on categories pertaining to device activity.

8. An apparatus comprising:
a memory for storing at least one script; and
a processor connected to the memory, the processor being configured to process and model the at least one script, determine a state transition diagram of the apparatus based on the script model, utilize the state transition diagram to determine a state of the apparatus, and display an image based on the state of the apparatus in response to internal and/or external events associated with the apparatus.

9. The apparatus of claim 8, wherein the processor is configured to process and model the at least one script in an n-vector space model.

10. The apparatus of claim 8, wherein the image is an animated image.

11. The method of claim 8, wherein the script comprises connections, the connections being based on categories pertaining to device activity.

12. A system comprising:
a first apparatus and a second apparatus, the first and second apparatus each including a memory for storing at least one script and a processor connected to the memory;
wherein each processor is configured to process and model the at least one script, determine a state transition diagram of a respective apparatus based on the script model, utilize the state transition diagrams to determine a state of the respective apparatus, and display an image based on the state of the respective apparatusin response to internal and/or external events of the respective apparatus.

13. The system of claim 12 wherein the first and second processor are configured to transfer an animated image from a display of the first apparatus to a display of a second apparatus.

14. The system of claim 13, wherein the memory of the first apparatus is configured to store a first portion of the animated image and the memory of the second apparatus is configured to store a second portion of the animated image.

15. The system of claim 13, wherein the processor of the second device is configured to display an interaction between the animated image from the first apparatus and an animated image of the second apparatus.

16. A computer program product comprising:
a computer useable medium having computer readable code means embodied therein for causing a computer to display an image based on a state of a device, the computer readable code means in the computer program product comprising:
computer readable code means for causing a computer to process and model at least one script stored in a first device, determine a state transition diagram of the first device based on the script model, utilize the state transition diagram to determine a state of the first device and display an image based on the state of the first device in response to internal and/or external events of the first device.

17. The computer program product of claim 16, further comprising computer readable code means for causing a computer to process and model the at least one script in an n-vector space model.

18. The computer program product of claim 16, wherein the image is an animated image.

19. The computer program product of claim 18, further comprising computer readable code means for causing a computer to transfer the animated image from a display of the first device to a display of a second device.

20. The computer program product of claim 19, wherein a first portion of the animated image is stored in the first device and a second portion of the animated image is stored in the second device.

21. The computer program product of claim 19, further comprising computer readable code means for causing a computer to display on the second device an interaction between the animated image from the first device and an animated image of the second device.
